(19) United States
(12) Patent Application Publication
(10) Pub. No.: US 2025/0124830 A1
(43) Pub. Date: Apr. 17, 2025

(54) MIXED REALITY DEVICE, ACQUISITION SYSTEM, PROCESSING METHOD, AND STORAGE MEDIUM

(71) Applicant: KABUSHIKI KAISHA TOSHIBA, Tokyo (JP)

(72) Inventors: Ren YAMASHITA, Yokohama Kanagawa (JP); Yusuke AOKI, Yokohama Kanagawa (JP); Takanori YOSHII, Kawasaki Kanagawa (JP); Kyotaro HAYASHI, Yokohama Kanagawa (JP); Hiroaki NAKAMURA, Kawasaki Kanagawa (JP); Yoshiyuki HIRAHARA, Mishima Shizuoka (JP); Masamitsu FUKUDA, Yokohama Kanagawa (JP); Takafumi KOZAKAI, Ota Tokyo (JP); Yasuo NAMIOKA, Nerima Tokyo (JP)

(21) Appl. No.: 18/830,017

(22) Filed: Sep. 10, 2024

(30) Foreign Application Priority Data
Oct. 11, 2023 (JP) 2023-176225

(51) Int. Cl. G09G 3/00; G02B 27/01; G06T 11/00

(52) U.S. Cl. CPC G09G 3/001; G02B 27/0172; G02B 27/0179; G06T 11/00; G02B 2027/0138; G02B 2027/0178; G02B 2027/0181; G09G 2340/0464; G09G 2354/00

(57) ABSTRACT

According to one embodiment, a mixed reality device is configured to display a virtual object corresponding to a fastening location where a screw is turned. The virtual object is displayed at a position away from the fastening location. The mixed reality device is configured to change a display position of the virtual object with respect to the fastening location according to a physique of a wearer.

### CROSS-REFERENCE TO RELATED APPLICATIONS

This application is based upon and claims the benefit of priority from Japanese Patent Application No. 2023-176225, filed on Oct. 11, 2023; the entire contents of which are incorporated herein by reference.

### FIELD Embodiments of the present invention generally relate to a mixed reality device, an acquisition system, a processing method, and a storage medium

### BACKGROUND

In tasks on articles, screws may be turned. There is a need for technology that can increase the efficiency of the task of turning screws.

### BRIEF DESCRIPTION OF THE DRAWINGS

FIG. 1 is a schematic view illustrating a mixed reality device according to an embodiment;

FIG. 2 is a schematic view illustrating an article to be worked on;

FIG. 3 is a schematic view illustrating an output example by a processing device according to the embodiment;

FIG. 4 is a schematic view illustrating an output example by the mixed reality device according to the embodiment;

FIG. 5 is a schematic view illustrating a state of the task;

FIG. 6 is a schematic view for explaining a display example by the mixed reality device according to the embodiment;

FIG. 7 is a schematic view for explaining a display example by the mixed reality device according to the embodiment;

FIG. 8 is a schematic view for explaining a display example by the mixed reality device according to the embodiment;

FIG. 9 is a schematic view for explaining a display example by the mixed reality device according to the embodiment;

FIG. 10 is a schematic view for explaining processing by the mixed reality device according to the embodiment;

FIG. 11 is a schematic view for explaining processing by the mixed reality device according to the embodiment;

FIG. 12 is a schematic view illustrating an example of a tool;

FIG. 13 is a flowchart illustrating a processing method according to the embodiment;

FIGS. 14A and 14B are schematic views for explaining display examples by the mixed reality device according to the embodiment;

FIGS. 15A and 15B are schematic views for explaining display examples by the mixed reality device according to the embodiment;

FIGS. 16A and 16B are schematic views for explaining display examples by the mixed reality device according to the embodiment;

FIGS. 17A and 17B are schematic views for explaining display examples by the mixed reality device according to the embodiment;

FIG. 18 is a schematic view for explaining a display example by the mixed reality device according to the embodiment;

FIG. 19 is a flowchart illustrating a method for checking a task;

FIG. 20 is a schematic view illustrating a display example by a mixed reality device according to the embodiment;

FIG. 21 is a schematic diagram illustrating a configuration of an acquisition system according to the embodiment;

FIG. 22 is a schematic view illustrating a display example by the mixed reality device according to a modification of the embodiment;

FIG. 23 is a flowchart illustrating a processing method according to the modification of the embodiment;

FIGS. 24A to 24C are schematic views illustrating display examples by the mixed reality device according to the modification of the embodiment; and

FIG. 25 is a schematic diagram illustrating a hardware configuration.

### DETAILED DESCRIPTION

According to one embodiment, a mixed reality device is configured to display a virtual object corresponding to a fastening location where a screw is turned. The virtual object is displayed at a position away from the fastening location. The mixed reality device is configured to change a display position of the virtual object with respect to the fastening location according to a physique of a wearer.

Various embodiments will be described hereinafter with reference to the accompanying drawings. The drawings are schematic and conceptual; and the relationships between the thickness and width of portions, the proportions of sizes among portions, etc., are not necessarily the same as the actual values thereof. Further, the dimensions and proportions may be illustrated differently among drawings, even for identical portions. In the specification and drawings, components similar to those described or illustrated in a drawing thereinabove are marked with like reference numerals, and a detailed description is omitted as appropriate.

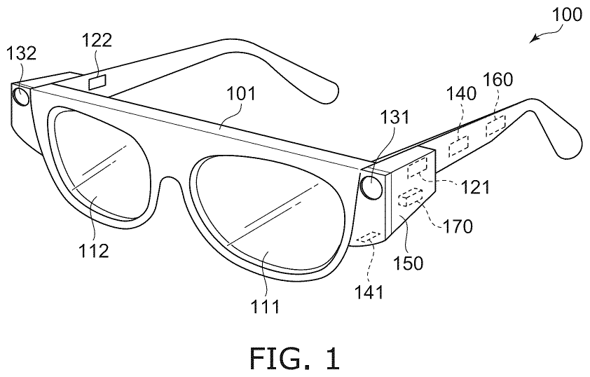

FIG. 1 is a schematic view illustrating a mixed reality device according to an embodiment.

Embodiments of the present invention relate to mixed reality (MR) devices. For example, as shown in FIG. 1, the MR device 100 according to the embodiment includes a frame 101, a lens 111, a lens 112, a projection device 121, a projection device 122, an image camera 131, a depth camera 132, a sensor 140, a microphone 141, a processing device 150, a battery 160, and a storage device 170.

In the illustrated example, the MR device 100 is a binocular-type head-mounted display. Two lenses 111 and 112 are embedded in the frame 101. The projection devices 121 and 122 project information onto lenses 111 and 112, respectively.

The projection device 121 and the projection device 122 display the recognition result of the worker's body, a virtual object, etc. on the lens 111 and the lens 112. Only one of the projection device 121 and the projection device 122 may be provided, and information may be displayed on only one of the lens 111 and the lens 112.

The lens 111 and the lens 112 are transparent. The worker can see the real-space environment through the lens 111 and the lens 112. The worker can also see the information projected onto the lens 111 and the lens 112 by the projection device 121 and the projection device 122. The projections by the projection device 121 and the projection device 122 display information overlaid on the real space.

The image camera 131 detects visible light and acquires a two-dimensional image. The depth camera 132 emits infrared light and acquires a depth image based on the reflected infrared light. The sensor 140 is a 6-axis detection sensor, and can detect 3-axis angular velocity and 3-axis acceleration. The microphone 141 accepts voice input.

The processing device 150 controls each element of the MR device 100. For example, the processing device 150 controls the display by the projection device 121 and the projection device 122. The processing device 150 detects the movement of the field of view based on the detection result by the sensor 140. The processing device 150 changes the display by the projection device 121 and the projection device 122 in response to the movement of the field of view. In addition, the processing device 150 can perform various processes using data obtained from the image camera 131 and the depth camera 132, the data of the storage device 170, etc.

The battery 160 supplies the power necessary for operation to each element of the MR device 100. The storage device 170 stores data necessary for the processing of the processing device 150, data obtained by the processing of the processing device 150, etc. The storage device 170 may be provided outside the MR device 100 and communicate with the processing device 150.

Not limited to the illustrated example, the MR device according to the embodiment may be a monocular-type head-mounted display. The MR device may be a glasses-type as illustrated, or may be a helmet type.

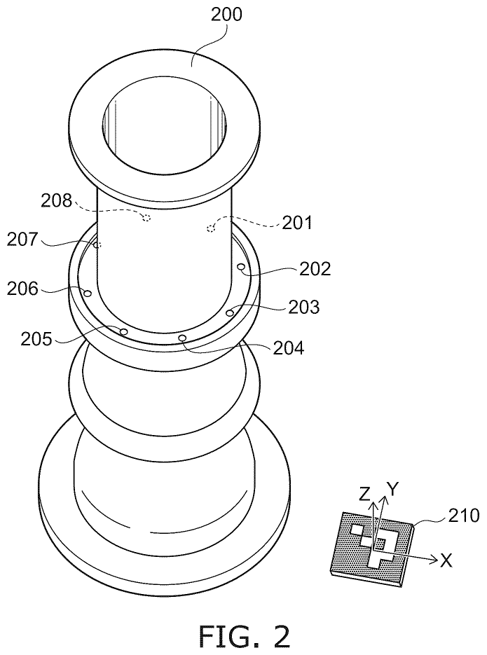

FIG. 2 is a schematic view illustrating an article to be worked on.

For example, a screw-fastening task is performed on the article 200 shown in FIG. 2. The article 200 is a cylindrical hollow member and has fastening locations 201 to 208. The worker uses a wrench and an extension bar to tighten a screw into each of the fastening locations 201 to 208.

A marker 210 is provided near the workpiece. In the illustrated example, the marker 210 is an AR marker. As described below, the marker 210 is provided for setting an origin of the three-dimensional coordinate system. Instead of the AR marker, a one-dimensional code (barcode), a two-dimensional code (QR code (registered trademark)), or the like may be used as the marker 210. Alternatively, instead of a marker, the origin may be indicated by a hand gesture. The processing device 150 sets the three-dimensional coordinate system based on a plurality of points indicated by the hand gesture.

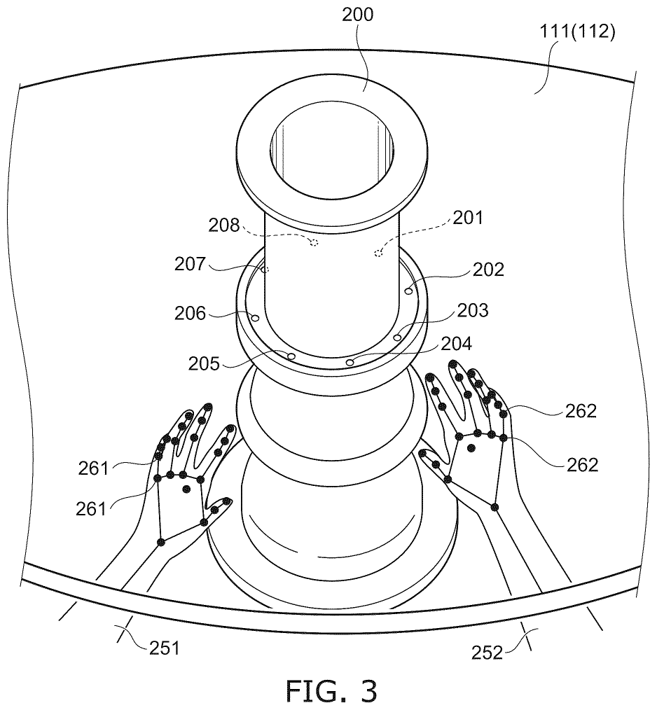

FIG. 3 is a schematic view illustrating an output example by the processing device according to the embodiment.

Here, an example in which a screw is tightened using the MR device 100 shown in FIG. 1 will be described. At the start of the fastening task, the image camera 131 and the depth camera 132 25 images the marker 210. The processing device 150 recognizes the marker 210 from the captured image. The processing device 150 sets a three-dimensional coordinate system based on the position of the marker 210.

The image camera 131 and the depth camera 132 images the article 200, the worker's left hand 251, and the worker's right hand 252. The processing device 150 recognizes the left hand 251 and the right hand 252 from the captured image. The processing device 150 may display the recognition results on the lens 111 and the lens 112 by the projection device 121 and the projection device 122. Hereinafter, the processing device displays information on the lens using the projection device, which is also referred to simply as “the processing device displays information”.

For example, as shown in FIG. 3, the processing device 150 displays the recognition result of the left hand 251 and the recognition result of the right hand 252 superimposed on the hands in real space. In the illustrated example, multiple virtual objects 261 and multiple virtual objects 262 are displayed as the recognition results of the left hand 251 and the right hand 252. The multiple virtual objects 261 represent multiple joints of the left hand 251, respectively. The multiple virtual objects 262 represent multiple joints of the right hand 252, respectively. Instead of joints, virtual objects (meshes) indicating the surface shape of the left hand 251 and the surface shape of the right hand 252 may be displayed, respectively.

When the left hand 251 and the right hand 252 are recognized, the processing device 150 measures the coordinates of each hand. Specifically, the hand includes multiple joints, such as DIP joints, PIP joints, MP joints, CM joints, and so on. The coordinates of any of these joints are used as the coordinates of the hand. The position of the center of gravity of the multiple joints may also be used as the coordinates of the hand. Alternatively, the overall center coordinates of the hand may be used as the coordinates of the hand.

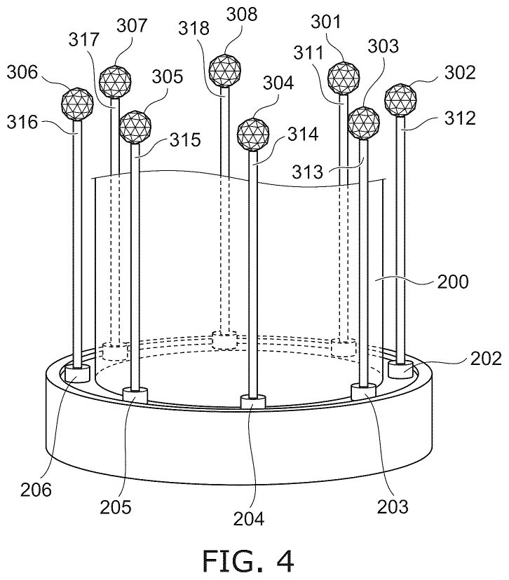

FIG. 4 is a schematic view illustrating an output example by the mixed reality device according to the embodiment.

As shown in FIG. 4, the processing device 150 displays virtual objects 301 to 308 and virtual objects 311 to 318. The virtual objects 301 to 308 are displayed at positions away from the fastening locations 201 to 208, respectively. The virtual objects 311 to 318 are displayed between the fastening locations 201 to 208 and the virtual objects 301 to 308, respectively. The virtual objects 311 to 318 respectively show which fastening locations the virtual objects 301 to 308 correspond to.

The virtual objects 301 to 308 respectively indicate the positions where the hand should be located when tightening the screws into the fastening locations 201 to 208. The virtual objects 311 to 318 indicate the position where the extension bar should be located when tightening the screws at the fastening locations 201 to 208. For example, the distance between the fastening locations 201 to 208 and the virtual objects 301 to 308 corresponds to the length of the extension bar.

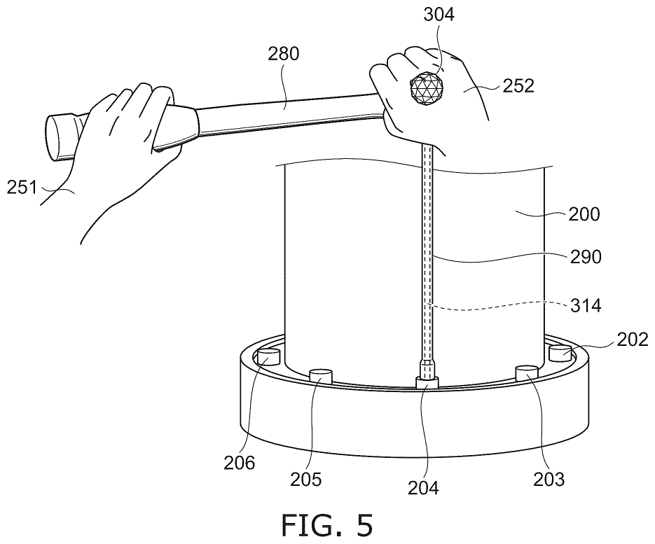

FIG. 5 is a schematic view illustrating a state of the task.

For example, as shown in FIG. 5, a wrench 280 and an extension bar 290 are used to turn a screw to each of the fastening locations 201 to 208. As an example, when tightening a screw into the fastening location 204, the worker places the screw in the screw hole of the fastening location 204. The worker fits one end of the extension bar 290 into the screw. The worker fits the head of the wrench 280 to the other end of the extension bar 290. The worker holds the head of the wrench 280 with one hand and holds the grip of the wrench 280 with the other hand. By turning the wrench 280, the screw is tightened into the fastening location 204 via the extension bar 290.

At this time, the worker places the extension bar 290 so that the extension bar 290 is in close proximity or contact with the virtual object 314. The worker also holds the head of the wrench 280 so that the hand comes into contact with the virtual object 304. By displaying the virtual objects, the worker can easily understand the positions where the tool and the hand should be located when turning the screw to the fastening location 204. Thereby, the work efficiency can be improved.

In the illustrated example, the virtual objects 301 to 308 are spherical, and the virtual objects 311 to 318 are rod-shaped. As long as the worker can see each virtual object, the shape of each object is not limited to this example. For example, the virtual objects 301 to 308 may be cubes, and the virtual objects 311 to 318 may be linear.

The processing device 150 may change the display positions of the virtual objects 301 to 308 and the virtual objects 311 to 318 according to the physique of the wearer of the MR device 100. The wearer of the MR device 100 is a worker. The “physique” referred to in the adjustment of the display position is the arm length. The “arm length” is the length from the shoulder to the hand in an outstretched state. In addition to the arm length, other data regarding the physique may also be referred.

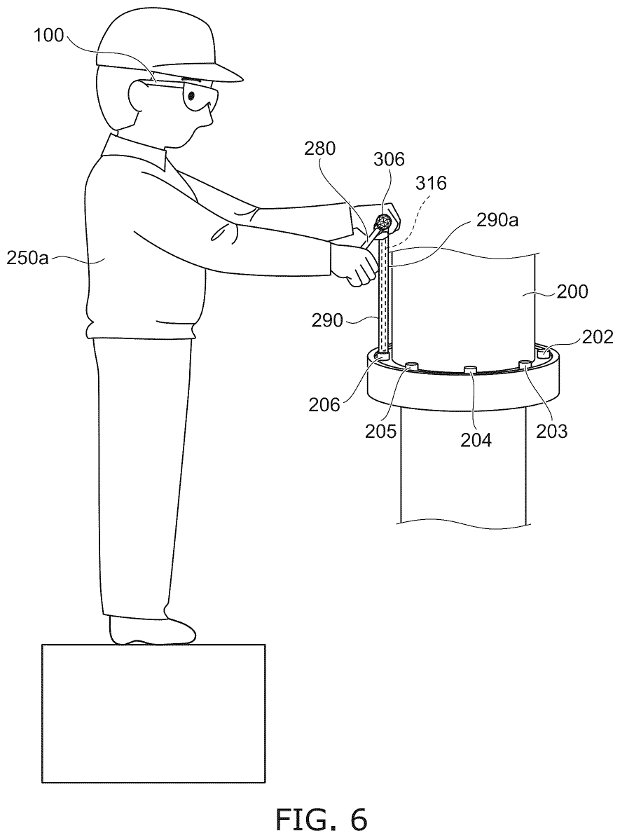

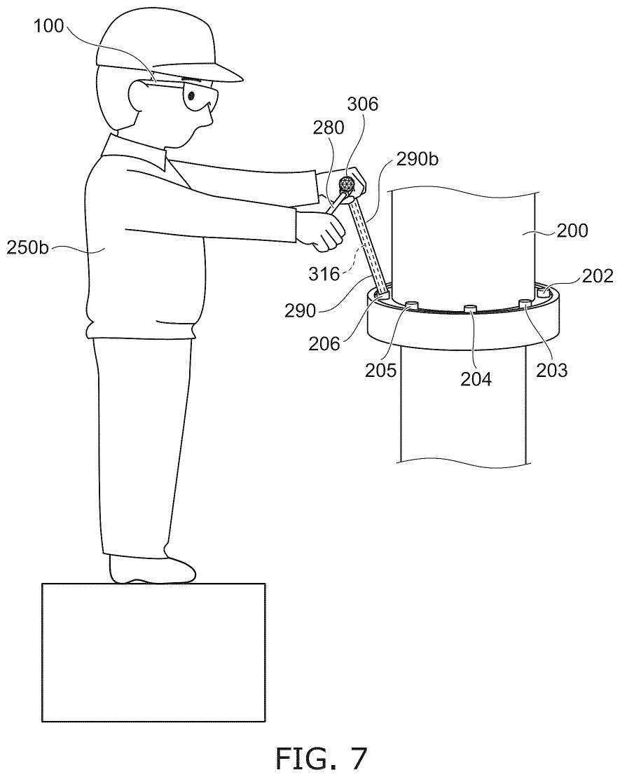

FIGS. 6 and 7 are schematic views for explaining display examples by the mixed reality device according to the embodiment.

FIG. 6 shows a state when a first worker 250a is working. FIG. 7 shows a state when a second worker 250b is working. The height of the first worker 250a is greater than the height of the second worker 250b. In addition, the arms of the first worker 250a are longer than the arms of the second worker 250b. In the illustrated example, the first worker 250a and the second worker 250b are on platforms of the same height, and they are turning screws into the fastening location 206.

The first worker 250a is tall and has long arms. Therefore, as shown in FIG. 6, the first worker 250a can located the hand directly above the fastening location 204 without fully extending the arm. The first worker 250a uses a wrench 280 and an extension bar 290a to turn a screw to the fastening location 206. In this case, the processing device 150 displays the virtual object 306 directly above the fastening location 206. Further, the processing device 150 displays the virtual object 316 along the vertical direction.

On the other hand, the arms of the second worker 250b are shorter than the arms of the first worker 250a. In order to located the hand directly above the fastening location 204, it is necessary to fully extend the arm. However, if the arm is fully extended, the task of turning screws becomes difficult. During the task, the posture becomes unstable, and the second worker 250b may fall over or fall down. Therefore, when the second worker 250b works, the hand of the second worker 250b is located more in front than the hand of the first worker 250a.

In addition, the height of the second worker 250b is less than that of the first worker 250a. Thus, the hand of the second worker 250b is located at a lower position than the hand of the first worker 250a. The second worker 250b uses an extension bar 290b that is shorter than the extension bar 290a. The second worker 250b uses the extension bar 290b tilted within the range that the extension bar 290b can be fitted to the screw.

In such a case, the processing device 150 displays the virtual object 306 obliquely above the fastening location 206. Additionally, the processing device 150 displays the virtual object 316 at an inclination with respect to the vertical direction. The display position (height) of the virtual object 306 shown in FIG. 7 is lower than the display position of the virtual object 306 shown in FIG. 6. In other words, the distance between the fastening location 206 and the virtual object 306 shown in FIG. 7 is shorter than the distance between the fastening location 206 and the virtual object 306 shown in FIG. 6. This is because the extension bar 290b is shorter than the extension bar 290a. In addition, the virtual object 316 shown in FIG. 7 is tilted more horizontally compared to the virtual object 316 shown in FIG. 6.

As shown in FIGS. 6 and 7, the processing device 150 changes the display positions of the virtual objects according to the worker's physique. This allows each worker to turn the screws in a posture that is easier to work with.

The processing device 150 may change the display positions of the virtual objects 301 to 308 and the virtual objects 311 to 318 according to the positional relationships between the fastening locations 201 to 208 and the MR device 100. After the three-dimensional coordinate system is set based on the marker 210, the processing device 150 continuously calculates the position of the MR device 100 in the three-dimensional coordinate system. Further, the positions of the fastening locations 201 to 208 in the three-dimensional coordinate system are registered in advance. Using this data, the processing device 150 calculates the positional relationships between each of the fastening locations 201 to 208 and the MR device 100.

The method for calculating the position of the MR device 100 is freely selectable, and an conventional positioning method may be used. As an example, the processing device 150 calculates the position and direction of the MR device 100 using the spatial mapping function. In the MR device 100, the distances to the surrounding objects of the MR device 100 are measured by the depth camera 132. From the measurement results by the depth camera 132, surface information of the surrounding objects can be obtained. Surface information includes the positions and directions of the surfaces of the objects. For example, the surface of each object is represented by multiple meshes, and the position and direction are calculated for each mesh. The processing device 150 calculates the relative position and relative direction of the MR device 100 with respect to the surfaces of the surrounding objects from the surface information. When the marker 210 is recognized, the position of each surface is also represented by the three-dimensional coordinate system based on the marker 210. The position and direction of the MR device 100 are calculated based on the positional relationships between the surfaces of the objects and the MR device 100.

The spatial mapping is performed repeatedly at predetermined intervals. Each time the spatial mapping is performed, the surface information of the surrounding objects is obtained. The processing device 150 calculates changes in surface positions and directions between the present spatial mapping result and the last spatial mapping result. When the surrounding objects are not moving, the changes in the positions and directions of the surfaces corresponds to the changes in the position and direction of the MR device 100. The processing device 150 calculates the change amounts of the position and direction of the MR device 100 based on the changes in the positions of the surfaces, the changes in the directions of the surfaces, the detection results of the sensor 140, etc. The processing device 150 updates the position and direction of the MR device 100 based on the obtained change amounts.

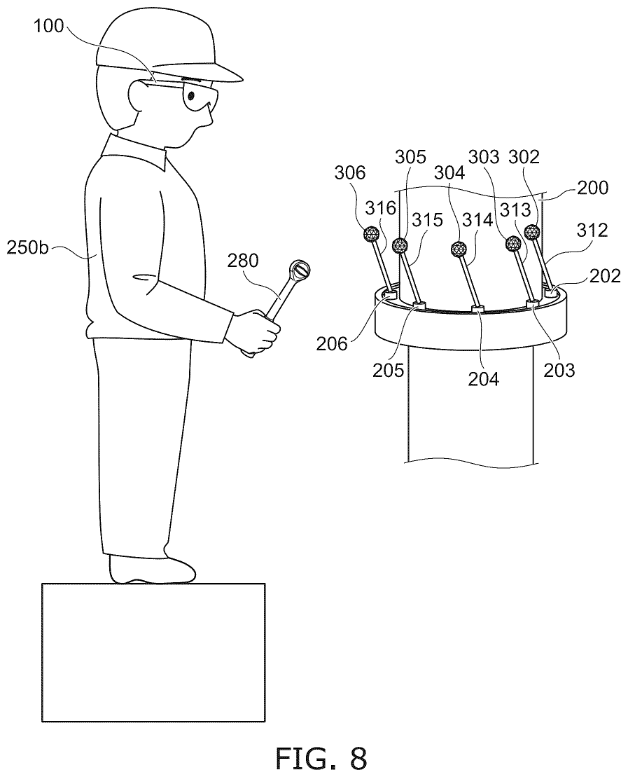

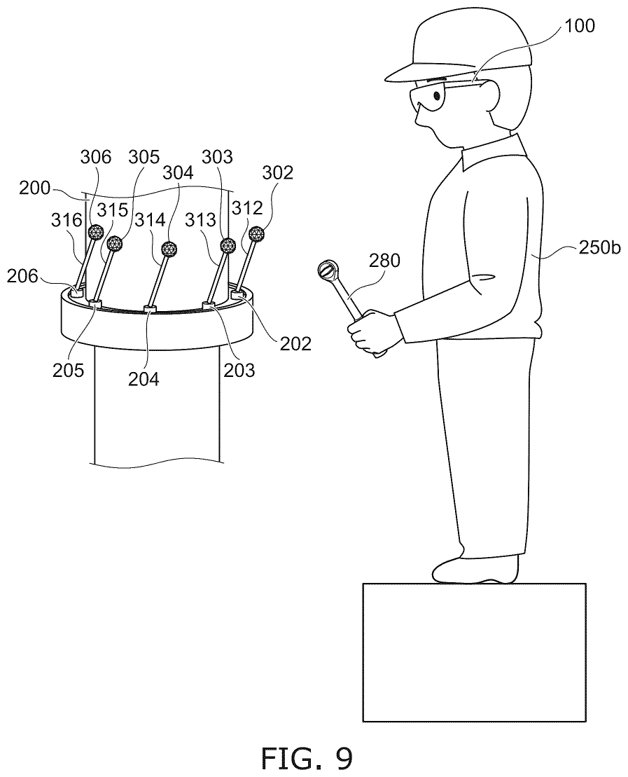

FIGS. 8 and 9 are schematic views for explaining display examples by the mixed reality device according to the embodiment.

In FIG. 8, the second worker 250b is located in the left direction (a first direction) of the drawing with respect to the article 200. In FIG. 9, the second worker 250b is located in the right direction (a second direction) of the drawing with respect to the article 200. The positional relationship between the MR device 100 and the article 200 in FIG. 8 is different from the positional relationship between the MR device 100 and the article 200 in FIG. 9. In the state shown in FIG. 8, the processing device 150 changes the display position of each of the virtual objects 301 to 308 to the left of the drawing within the range where the extension bar 290b can be fitted to the screws. The virtual objects 311 to 318 are tilted toward the left direction of the drawing with respect to the vertical direction. In the state shown in FIG. 9, the processing device 150 changes the display positions of the virtual objects 301 to 308 to the right of the drawing within the range where the extension bar 290b can be fitted to the screws. The virtual objects 311 to 318 are tilted toward the right of the drawing with respect to the vertical direction. By changing the display positions of the virtual objects, the virtual objects are displayed at positions closer to the MR device 100.

As shown in FIGS. 8 and 9, the processing device 150 changes the display positions of the virtual objects according to the positional relationships between each fastening location and the MR device 100. This allows each worker to turn screws in a posture that is easier to work with.

One advantage of the embodiment will be described.

As shown in FIG. 4, by displaying the virtual objects 301 to 308, the worker can easily understand the positions where the hand should be located when turning the screws to the fastening locations 201 to 208. Thereby, work efficiency can be improved. On the other hand, when the task is actually performed, the optimal position of the hand may vary depending on the worker's physique. For example, the standard position of each virtual object may be suitable for a tall worker, but may not be suitable for a short worker. In such a case, the short worker may be forced to take an unsuitable posture in order to locate their hand at the display position of the virtual object. As a result, work efficiency may decrease or workers may fall.

Regarding this problem, in the embodiment of the present invention, the display position of the virtual object with respect to the fastening location is changed according to the physique of the worker (the wearer of the MR device 100). By changing the display position of the virtual object, each worker can work in a more appropriate posture. This can improve work efficiency. In addition, workers can work more safely.

As a specific example, as shown in FIGS. 6 and 7, the first worker 250a having the first height and the second worker 250b having the second height perform the same task. The height of the second worker 250b is less than the height of the first worker 250a. The display position of the virtual object 306 during the task of the second worker 250b is lower than the display position of the virtual object 306 during the task of the first worker 250a. In other words, the distance between the fastening location 206 and the virtual object 306 during the task of the second worker 250b is shorter than the distance between the fastening location 206 and the virtual object 306 during the task of the first worker 250a. In addition, the inclination of the virtual object 316 during the task of the first worker 250a is different from the inclination of the virtual object 316 during the task of the second worker 250b.

Another advantage of the embodiment will be described.

Depending on the size or shape of the article, the fastening location may be at a position that is difficult to reach. In such a case, it may be difficult for a worker to locate the hand at the displayed position of the virtual object. As a result of locating the hand at the display position of the virtual object in an unsuitable posture, work efficiency may decrease or the worker may fall.

Regarding this problem, in the embodiment of the present invention, the display position of the virtual object with respect to the fastening location is changed according to the positional relationship between the fastening location and the MR device 100. By changing the display position of the virtual object according to the positional relationship, each worker can work in a more appropriate posture. This allows workers to work more safely. In addition, work efficiency can be improved.

As a specific example, in the state shown in FIG. 8, the second worker 250b (MR device 100) is located in a first direction with respect to the article 200. In this case, the processing device 150 changes the display positions of the virtual objects 301 to 308 toward the first direction. In the state shown in FIG. 9, the second worker 250b (MR device 100) is located in a second direction opposite to the first direction with respect to the article 200. In this case, the processing device 150 changes the display positions of the virtual objects 301 to 308 toward the second direction. In addition, the processing device 150 changes the inclinations of the virtual objects 311 to 318 according to changes in the display positions of the virtual objects 301 to 308.

The method of changing the display position is freely selectable. For example, the standard arm length is registered in advance, and the horizontal position of the virtual object changes according to the difference between the standard arm length and the worker's arm length. Additionally, the longer the distance between the standard position of the virtual object and the MR device 100, the greater the change amount of the display position of the virtual object.

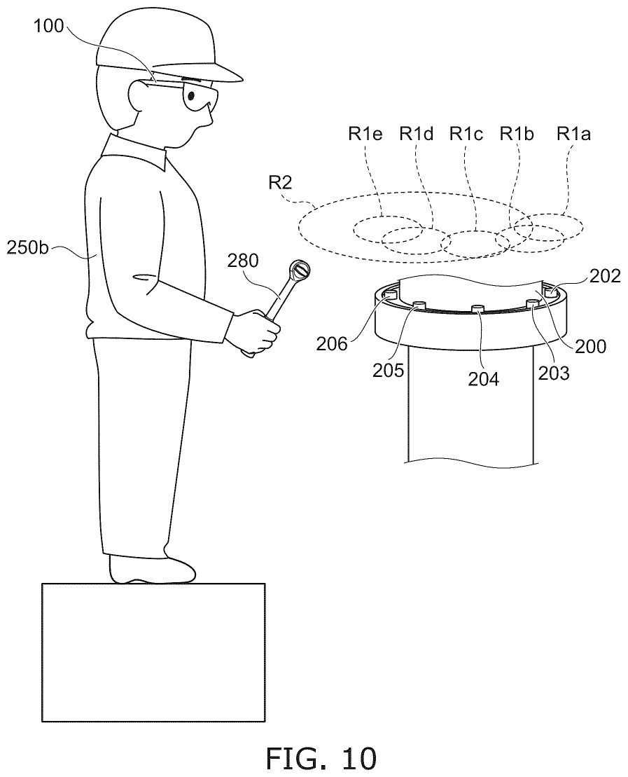

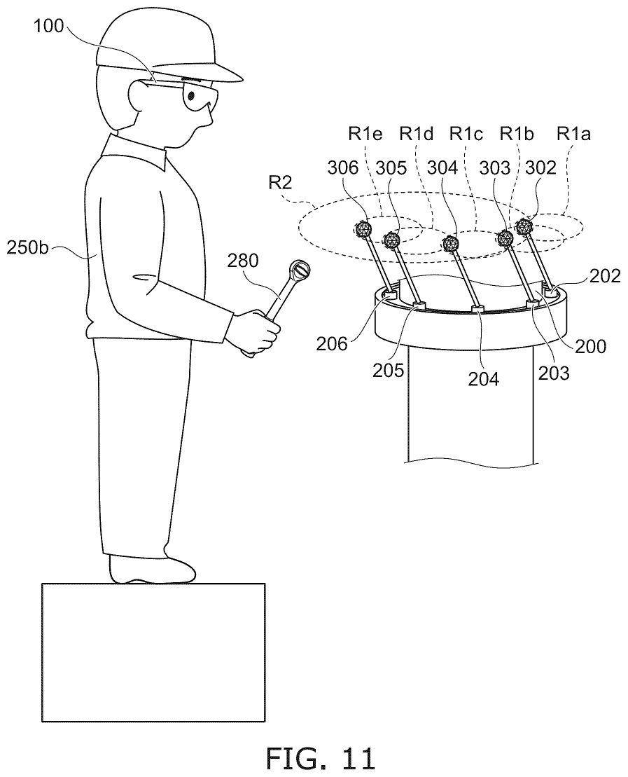

FIGS. 10 and 11 are schematic views for explaining processing by the mixed reality device according to the embodiment.

In order to display the virtual object at a more desirable position, the following process may be executed. First, the processing device 150 calculates the first range that can be worked for the fastening location based on the position of the fastening location, the length of the extension bar used, and the allowable angle of the extension bar. As a specific example, as shown in FIG. 10, the first ranges R1a to R1d are calculated. The first ranges R1a to R1d indicate workable ranges for the fastening locations 201 to 204, respectively.

Next, based on the position of the MR device 100 and the length of the worker's arm, the second range R2 in which the worker can work is calculated. The processing device 150 calculates ranges in which each of the first ranges R1a to R1d and the second range R2 overlap. The processing device 150 adopts positions closest to the MR device 100 in the overlapping ranges as display positions of the virtual objects. As shown in FIG. 11, the processing device 150 displays the virtual objects 301 to 304 at the adopted positions. In FIGS. 10 and 11, the virtual objects 301 to 304 are omitted, but the display positions of these virtual objects can also be changed by the same method.

When the first range and the second range do not overlap, the processing device 150 does not display the virtual object. The fact that the first and second ranges do not overlap indicates that the position of the worker with respect to the fastening location to be worked is inappropriate. If the worker performs the task in an inappropriate position, work efficiency or safety may be reduced. When the first range and the second range do not overlap, the processing device 150 may output an alert encouraging the worker to move to a more appropriate position.

After the virtual objects are displayed, the processing device 150 may determine whether a prescribed physical object comes into contact with the virtual objects 301 to 308. For example, the processing device 150 determines whether the hand comes into contact with the virtual object. Specifically, the processing device 150 calculates the distances between the coordinates of the hand and each of the virtual objects 301 to 308. When any distance is less than a preset threshold, the processing device 150 determines that the hand comes into contact with that virtual object. As an example, in FIG. 4, the diameter of the virtual objects 301 to 308 (spheres) corresponds to the threshold. The sphere indicates the range within which the hand is determined to come into contact with the virtual object.

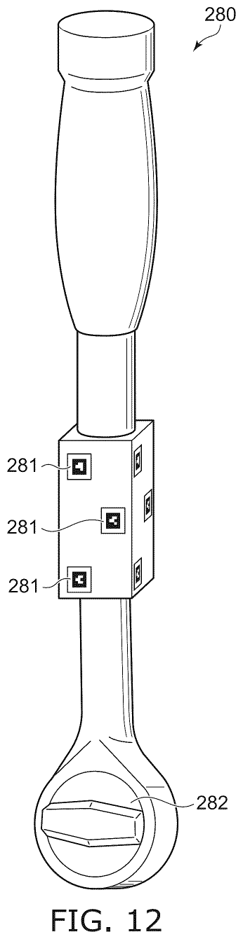

FIG. 12 is a schematic view illustrating an example of a tool.

The processing device 150 may determine whether the tool comes into contact with the virtual objects 301 to 308. For example, as shown in FIG. 12, multiple markers 281 are attached to the wrench 280. The processing device 150 recognizes multiple markers 281 from images captured by the image camera 131. The processing device 150 measures the coordinates of each marker 281. The positional relationship between the multiple markers 281 and the head 282 of the wrench 280 is registered in advance. The processing device 150 calculates the coordinates of the head 282 based on the coordinates of the recognized at least three markers 281 and the pre-registered positional relationship. The processing device 150 calculates the distances between the coordinates of the head 282 and each of the virtual objects 301 to 308. When any distance is less than a preset threshold, the processing device 150 determines that the wrench 280 comes into contact with the virtual object.

When the prescribed physical object comes into contact with one of the virtual objects 301 to 308, it can be estimated (inferred) that the screw is being turned to the fastening location corresponding to the one of the virtual objects 301 to 308. Hereinafter, among one or more fastening locations, the fastening location that is estimated to be being worked on based on the contact between the prescribed physical object and the virtual object is referred to as a “work location”. In the case where the work location is estimated, the processing device 150 may record that the screw has been turned to the work location. Thus, a task record can be automatically generated.

The tool used may be a digital tool capable of detecting torque. In such a case, the processing device 150 receives the detected torque from the tool. The torque required for fastening may be set in advance. The tool may determine whether or not the required torque has been detected, and transmit the determination result to the processing device 150. In addition, the tool transmits the rotation angle, the time when the torque is detected, etc. to the processing device 150. The processing device 150 associates the data received from the tool with data related to the work location. Thus, a more detailed task record is automatically generated.

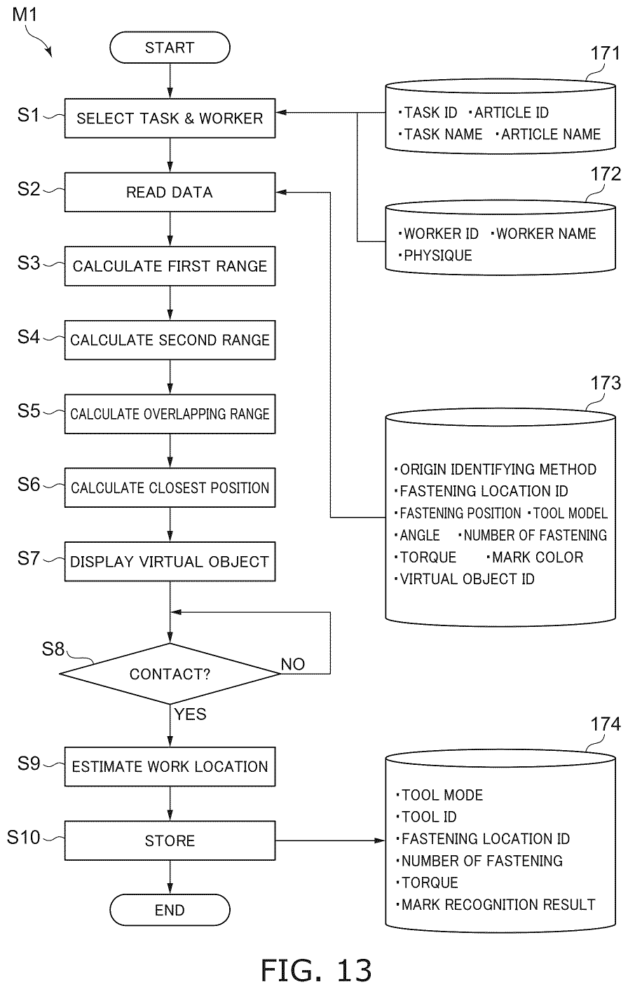

FIG. 13 is a flowchart illustrating a processing method according to the embodiment.

In the processing method M1 shown in FIG. 13, the task data 171, the worker data 172, and the fastening location data 173 are referred. The task data 171, the worker data 172, and the fastening location data 173 are stored in the storage device 170 before the task. The task data 171, the worker data 172, and the fastening location data 173 may be stored in a storage area other than the MR device 100. In such a case, the processing device 150 accesses the task data 171, the worker data 172, and the fastening location data 173 via wireless communication or a network.

First, the processing device 150 accepts the selection of a task and a worker (step S1). In the selection of a task, the task data 171 is loaded. In the selection of a worker, the worker data 172 is loaded. The task data 171 includes task IDs, task names, article IDs, and article names. The processing device 150 can accept either a task ID, a task name, an article ID, or an article name as the selection of task. The worker data 172 includes worker IDs, worker names, and physiques. The processing device 150 can accept a worker ID or a worker name as the selection of worker.

For example, the task and the worker may be selected by a worker or by a higher-level system. Based on the data obtained from a sensor provided in the workplace or a reader provided in the workplace, the processing device 150 may determine the task and the worker. Based on a schedule prepared in advance, the task and the worker may be automatically selected.

When the task and the worker are selected, the processing device 150 reads the data stored in the fastening location data 173 (step S2). The fastening location data 173 includes a method for identifying the origin, an ID of each fastening location, the position of each fastening location, the model of the tool used, the angle of the extension bar, the required number of fastenings, the required torque, the color of a mark, and the ID of each virtual object.

As methods for identifying the origin, a method using a marker or a method using a hand gesture is registered. The ID of each fastening location is a unique character string for identifying each fastening location. The coordinates in the three-dimensional coordinate system based on the origin are registered as the position of the fastening location. The model of the tool indicates the classification of the tool by structure, appearance, performance, etc. For example, the length of the extension bar is specified from the model of the extension bar. The angle indicates the limit value of the angle of the extension bar that can be fitted to the screw when turning the screw to the fastening location.

During the work, a mark may be attached when the screw has been turned to the fastening location. The “mark color” represents the color of the mark attached to each fastening location. When a mark of a different color is attached according to the number of times the screw has been turned, the color of the mark for each number of times is registered. The ID of each virtual object is a character string for identifying the data of a virtual object registered in advance, and it is associated with each fastening location.

The processing device 150 calculates the first range based on the position of the fastening location, the length of the extension bar used, and the allowable angle of the extension bar (step S3). The first range indicates the positions of the hand where the screw can be turned to the fastening location without considering the worker's physique. The processing device 150 calculates the second range based on the position of the MR device 100 and the length of the worker's arm (step S4). The second range indicates the positions of the hand where the worker can work. The arm length is stored in advance in the worker data 172 as physique data.

As the physique data, data other than the arm length may be further referred to. For example, three sets of data: arm length, distance from eyes to chin, and neck length are referred to. When the person extends the arm straight in front, the sum of the distance from the eyes to the chin and the length of the neck is approximately equal to the vertical distance between the shoulder and the MR device 100. Consider an imaginary triangle with the hands, the base of the neck, and the eyes as vertices. In that case, the distance between the hand and the MR device 100 can be calculated from the arm length, the distance from the eyes to the chin, and the length of the neck using trigonometry. The position of the MR device 100 is repeatedly calculated by spatial mapping. The processing device 150 can calculate the second range based on the position of the MR device 100 and the distance between the hand and the MR device 100.

As the physique data, a shoulder width may be referred to. The shoulder width is the distance between the left shoulder and the right shoulder. When the hand is extended straight in front, the distance in the left and right direction between the eyes (MR device 100) and the hand is approximately half the shoulder width. Consider an imaginary triangle with the hand, the eyes (MR device 100), and the shoulder as vertices. In that case, the distance between the hand and the MR device 100 can be calculated from the arm length and half the shoulder width using trigonometry. The processing device 150 can calculate the second range based on the position of the MR device 100 and the distance between the hand and the MR device 100. The second range may be calculated using four sets of data: arm length, distance from eyes to chin, neck length, and shoulder width.

The processing device 150 calculates the range where the first range and the second range overlap (step S5). The processing device 150 calculates the closest position to the MR device 100 from the overlapping range (step S6). The processing device 150 displays the virtual object at the closest position (step S7).

When multiple virtual objects are displayed, the steps S3 to S7 are executed for each virtual object. In addition, after the virtual object is displayed, the steps S3 to S7 are repeated. Thereby, the display position of the virtual object is updated according to the positional relationship between the fastening location and the MR device 100.

After displaying the virtual object, the processing device 150 determines whether a prescribed physical object comes into contact with the virtual object (step S8). When the prescribed physical object comes into contact with the virtual object, the processing device 150 estimates the work location based on the determination result (step S9). That is, it is estimated that the screw is being turned to the fastening location corresponding to the virtual object. The processing device 150 stores a record of the task for the work location (step S10).

In the step S10, the processing device 150 associates the torque detected by the tool with the ID of the fastening location at which the screw is estimated to be turned, and stores them in the history data 174. As shown in FIG. 13, the processing device 150 may further associate the model and ID of the tool used, the number of times the screw has been tightened, and the recognition result of the mark with the ID of the fastening location. The mark is recognized by the processing device 150 from the image captured by the image camera 131. The processing device 150 extracts a cluster of pixels of the mark color from the image and counts the number of pixels in the cluster. When the number of pixels exceeds a preset threshold, it is determined that a mark has been attached.

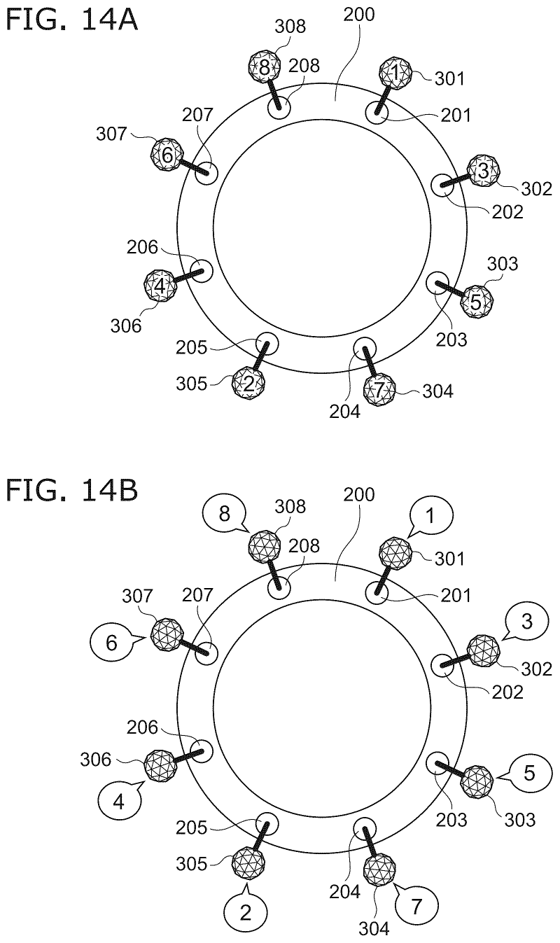

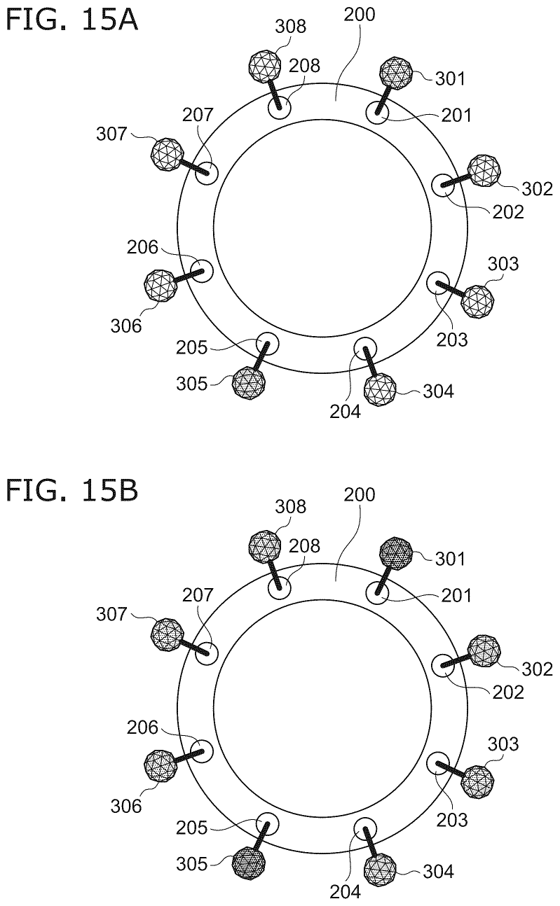

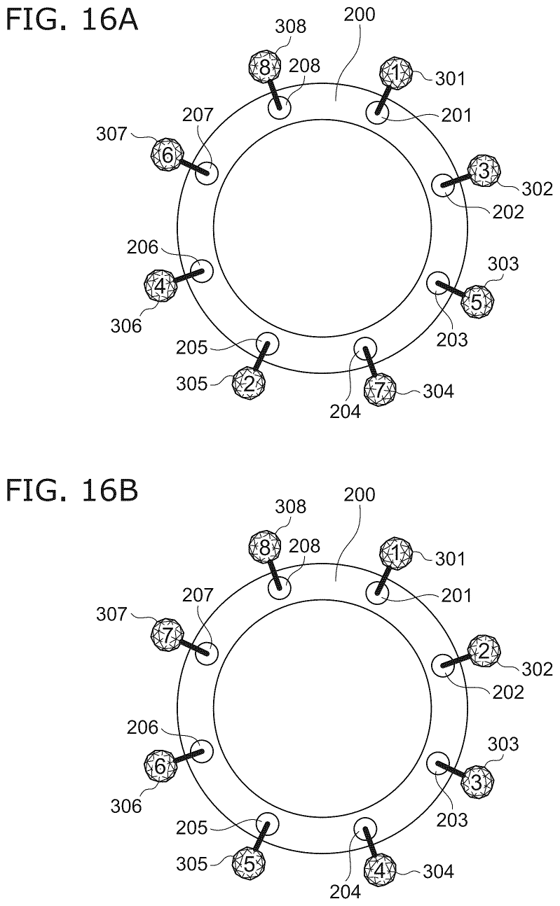

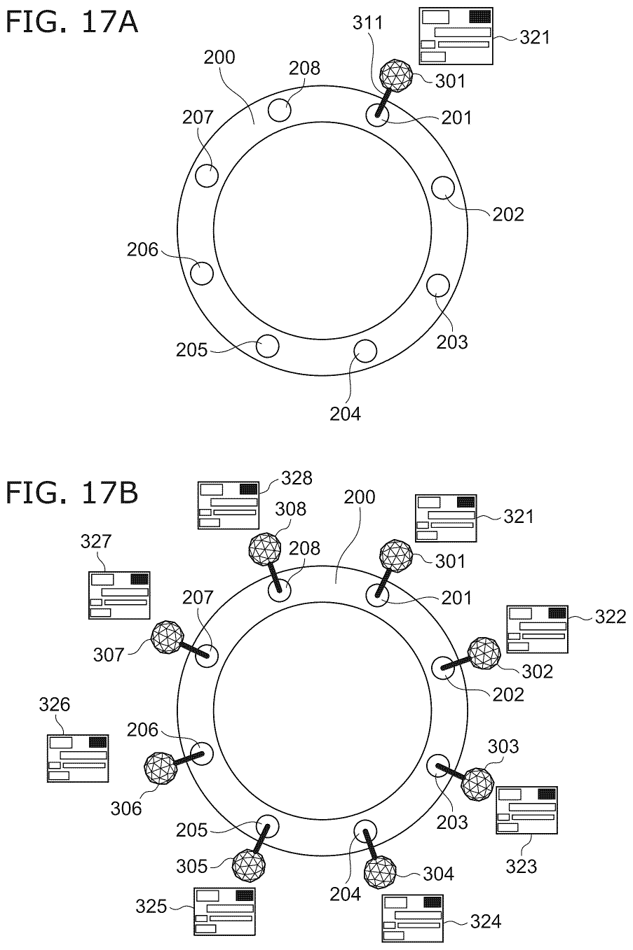

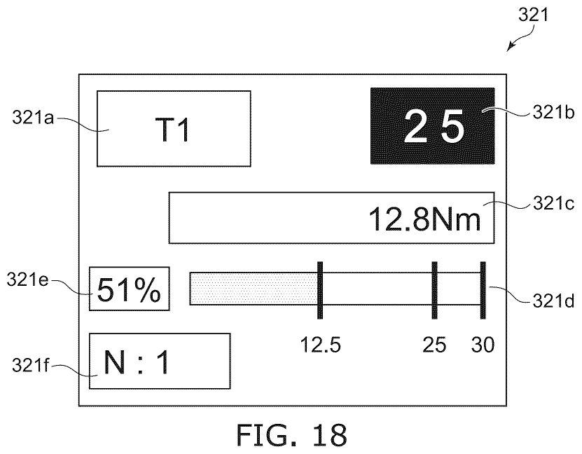

FIG. 14A, FIG. 14B, FIG. 15A, FIG. 15B, FIG. 16A, FIG. 16B, FIG. 17A, FIG. 17B, and FIG. 18 are schematic views for explaining display examples by the mixed reality device according to the embodiment.

The processing device 150 may display information indicating the order of tasks on the virtual objects 301 to 308. For example, as shown in FIG. 14A, numbers indicating the order are displayed superimposed on the virtual objects 301 to 308. As shown in FIG. 14B, numbers indicating the order may be displayed near the virtual objects 301 to 308.

The display of the virtual object corresponding to the fastening location where the screw has been turned may differ from the display of the virtual object corresponding to the fastening location where the screw has not been turned. In the example shown in FIG. 15A, the screws have been turned to the fastening location 201 and the fastening location 205, and the screws have not been turned to the other fastening locations. The color of the virtual object 301 corresponding to the fastening location 201 and the color of the virtual object 305 corresponding to the fastening location 205 are different from the colors of the virtual objects 302 to 304 and the colors of the virtual objects 306 to 308. Instead of color, the size or shape of the virtual object may change.

In the case where the screw is turned multiple times to one fastening location, the display of the virtual object may change according to the number of times the screw has been turned. For example, the color of the virtual object 301 and the color of the virtual object 305 shown in FIG. 15A indicate that the first screw-tightening has been performed. The color of the virtual object 301 and the color of the virtual object 305 shown in FIG. 15B indicate that the second screw-tightening has been performed. Instead of color, the size or shape of the virtual object may change according to the number of times.

The order of tasks may vary depending on the number of times the screw has been turned. For example, FIG. 16A shows a state in which the screws have not been turned for any of the fastening locations. In this state, the screws are tightened in diagonal order for each fastening location. In other words, the screws are turned in the order of fastening location 201, fastening location 205, fastening location 202, fastening location 206, fastening location 203, fastening location 207, fastening location 204, and fastening location 208. FIG. 16B shows the state after the screws are tightened in the diagonal order. In this state, the screws are turned clockwise or counterclockwise to the fastening locations 201 to 208. The order displayed on the virtual objects 301 to 308 is different between the state shown in FIG. 16A and the state shown in FIG. 16B.

The number of times the screw has been turned is counted based on the data stored in the history data 174. When a screw is turned to one fastening location, the task record indicating this is stored in the history data 174. The processing device 150 counts the number of times the screw has been turned for each fastening location from the record stored in the history data 174, and controls the display of each virtual object based on the counted number of times.

The processing device 150 may display a virtual panel containing information related to the task. In the example shown in FIG. 17A, a virtual panel 321 is displayed. The panel 321 is displayed near the virtual object 301 corresponding to the fastening location 201. As shown in FIG. 17B, panels 321 to 328 may be displayed near the virtual objects 301 to 308, respectively.

As shown in FIG. 17A, among the multiple virtual objects, only the virtual object corresponding to the fastening location 201 where the screw is to be turned next may be displayed. Alternatively, as shown in FIG. 17B, more virtual objects may be displayed. By displaying only the virtual object corresponding to the fastening location where the screw should be turned, the amount of information visible to the worker is reduced, making it easier for the worker to understand the next task. On the other hand, by displaying more virtual objects, the worker can easily check the task flow. The worker may be able to switch between the state shown in FIG. 17A and the state shown in FIG. 17B. For example, the processing device 150 accepts a switching instruction via a voice command or a hand gesture.

As an example, as shown in FIG. 18, the panel 321 includes an identification number 321a, a specified torque value 321b, a detected value 321c, a meter 321d, a percentage 321e, and a number of times 321f. The identification number 321a is the identification number of the fastening location 201. The specified torque value 321b is the torque value specified for the screw-tightening to the fastening location 201. The detected value 321c is the torque value detected by the tool. The meter 321d indicates the specified torque value and the detected torque value. The percentage 321e indicates the ratio of the detected value to the specified torque value. The number of times 321f indicates the number of times the screw has been tightened into the fastening location 201.

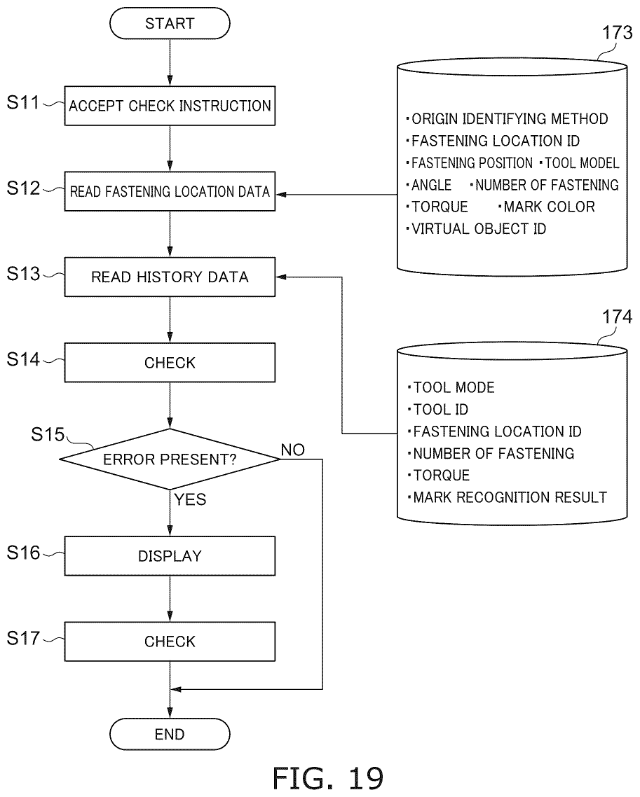

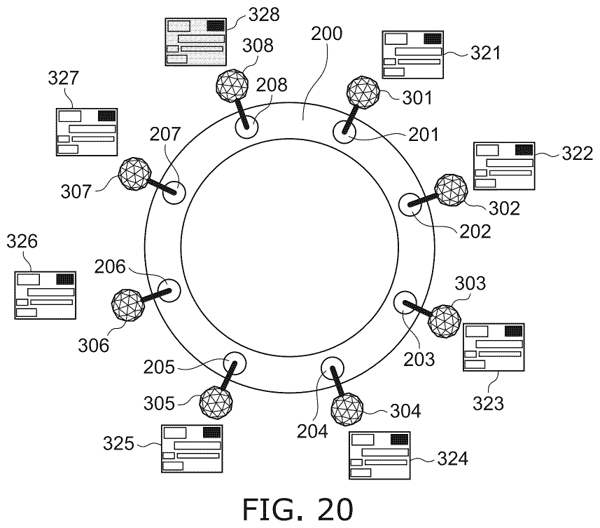

FIG. 19 is a flowchart illustrating a method for checking a task. FIG. 20 is a schematic view illustrating a display example by a mixed reality device according to the embodiment.

The processing device 150 may check whether the screws have been appropriately turned to all fastening locations after the task is completed. Specifically, the processing device 150 receives a check instruction (step S11). The check instruction may be input by the worker or from a higher-level system. Upon receiving the instruction, the processing device 150 reads the data of the fastening location data 173 (step S12) and reads the data of the history data 174 (step S13).

The processing device 150 checks whether the screws have been appropriately turned to the fastening locations to be worked on (step S14). Specifically, the processing device 150 checks whether the screw has been turned the required number of times for each fastening location. In addition, the processing device 150 checks whether the required torque has been detected in each screw-tightening.

The processing device 150 determines whether there is an error based on the results of the checks (step S15). When the torque detected in any of the screw-tightening is less than the required torque registered in advance, or when the number of times the screw has been turned for any of the fastening locations is less than the required number of times registered in advance, the processing device 150 determines that there is an error in the task.

When there is no error, the processing device 150 terminates the process. When there is an error, the processing device 150 displays, to the worker, the fastening location where the error is detected (step S16). For example, as shown in FIG. 20, the processing device 150 changes the color of the panel 328 corresponding to the fastening location where the error is detected to be different from the colors of the other panels 321 to 327. The shape or size of the panel 328 may be different from the shapes or sizes of the panels 321 to 327. A new virtual object for highlighting the panel 328 may be displayed. The information contained in the panel 328 may be highlighted. For example, the panel 328 may be highlighted by making the color or size of the characters included in the panel 328 different from the color or size of the characters included in the panels 321 to 327.

Thereafter, when the screw has been turned to the fastening location where the error was detected, the processing device 150 checks the task (step S17). When it is verified that the screw has been turned appropriately, the processing device 150 terminates the process. By performing the check, it is possible to suppress the production of inappropriately worked articles 200. For example, the quality of the article 200 can be improved.

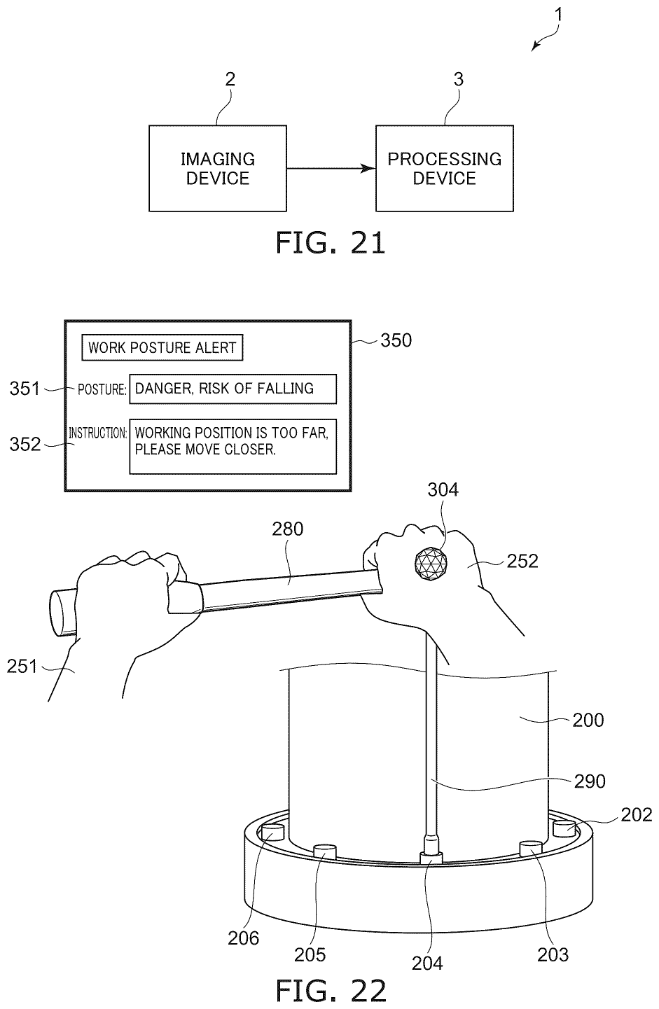

FIG. 21 is a schematic diagram illustrating a configuration of an acquisition system according to the embodiment.

The acquisition system 1 shown in FIG. 21 acquires physique data referred to by the processing device 150. The acquisition system 1 includes an imaging device 2 and a processing device 3.

The imaging device 2 images a worker and acquires an image. At least an image of the upper body of the worker is obtained. The imaging device 2 includes a camera. The processing device 3 receives the image acquired by the imaging device 2. The processing device 3 inputs the image into the pose estimation model. When an image is input, the pose estimation model estimates the posture of the person in the image. The posture is represented by the joints of the human body and the skeleton connecting the joints. The joints include the head, neck, shoulders, elbows, wrists, hips, knees, ankles, etc.

The pose estimation model preferably includes a neural network. More preferably, the pose estimation model includes a convolutional neural network (CNN). As the pose estimation model, OpenPose, DarkPose, CenterNet, etc. can be used.

The processing device 3 acquires the estimation result output by the pose estimation model. The processing device 3 calculates physique data such as the height of the worker from the estimated posture. Additionally, the worker's height, neck position, shoulder position, etc., may be calculated as physique data. The processing device 3 stores the calculated physique data in the worker data 172. By using the acquisition system 1, the physique data used in the processing device 150 can be automatically acquired.

The MR device 100 may have functions as the acquisition system 1. For example, the image camera 131 photographs the worker's arm while the worker fully extends the arm forward. The processing device 150 measures the coordinates of the worker's hand and calculates the distance between the MR device 100 and the coordinates of the hand. The distance is proportional to the worker's arm length and indicates the limit of the range in which the worker can work. The processing device 150 stores the distance in the worker data 172 as the data of the worker's arm length.

### Modification

The processing device 150 may determine whether or not the worker's posture is appropriate instead of controlling the display position of the virtual object. Alternatively, the processing device 150 may perform posture determination in addition to controlling the display position of the virtual object.

Specifically, the processing device 150 estimates the posture of the worker based on the position of the MR device 100, the position of the worker's hand, and the worker's physique. The processing device 150 determines whether the estimated posture is appropriate. For example, when the posture is inappropriate for the task or the posture is unsafe, the processing device 150 determines that the posture is not appropriate.

In estimating the posture, the processing device 150 measures the position of the MR device 100 and the position of each of the worker's hand. The processing device 150 calculates the distance between the MR device 100 and each hand. Further, the processing device 150 refers to the arm length stored in the worker data 172. The processing device 150 sets the first range based on the arm length. The first range may be set using the distance from the eyes to the chin, neck length, shoulder width, etc., in addition to the arm length. The processing device 150 compares the calculated distance with the first range.

The distance between the MR device 100 and the hand becomes longer as the worker extends the arm. The closer the distance is to the length of the pre-registered arm, the more it indicates that the worker's arm is extended to the limit. When the distance is too short compared to the pre-registered arm length, the worker's hand is indicated to be located close to the body. For example, the first range is calculated by multiplying the pre-registered arm length by a predetermined ratio. The predetermined ratio may be set appropriately from the viewpoint of safety or task efficiency. For example, as the lower limit of the first range, a value of 0.5 times the arm length is set. As the upper limit of the first range, a value of 0.8 times the arm length is set. When the distance is outside the first range, it indicates that the range of motion of the worker's arm is narrow and the posture is inappropriate for the task. Therefore, when any distance falls outside the first range, the processing device 150 determines that the worker's posture is not appropriate.

FIG. 22 is a schematic view illustrating a display example by the mixed reality device according to the modification of the embodiment.

FIG. 22 shows a state where the worker is performing a task with the arm extended. The processing device 150 measures the position of the MR device 100, the position of the left hand 251, and the position of the right hand 252. The processing device 150 calculates the distance between the MR device 100 and the left hand 251 and the distance between the MR device 100 and the right hand 252. The processing device 150 compares each distance to the first range.

When the worker almost fully extends the arms, it is determined that each of both distances falls outside the first range. When the task is determined to be inappropriate, the processing device 150 displays an alert 350. As an example, the alert 350 includes a cause 351 that the posture was determined to be inappropriate and an instruction 352 to the worker. By displaying the alert 350, the worker can be encouraged to work in a more appropriate posture.

The processing device 150 may further use the inclination of the MR device 100 to determine whether the posture is appropriate. The inclination of the MR device 100 is detected by the sensor 140. Here, the inclination refers to the direction (angle) of the MR device 100 with respect to a reference direction. The reference direction is the orientation of the MR device 100 when the worker is facing horizontally. The processing device 150 determines that the task is not appropriate when the distance between the MR device 100 and the hand falls outside the first range or when the inclination exceeds the first threshold. The first threshold is appropriately set from the viewpoint of task safety. For example, any value in the range of 15 degrees to 45 degrees is set as the first threshold. when the inclination exceeds the first threshold, it indicates that the worker is leaning forward. when the worker leans forward, the worker may fall over. when the task is carried out at a high position, the worker may fall down.

When the task is appropriate, the processing device 150 does not display any information. Alternatively, the processing device 150 may display information indicating that the task is appropriate.

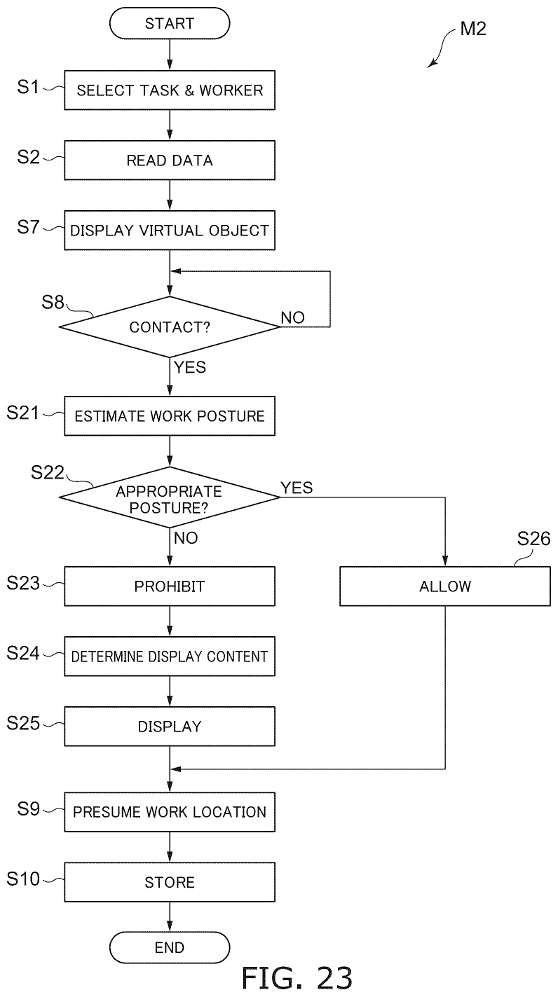

FIG. 23 is a flowchart illustrating a processing method according to the modification of the embodiment.

In the processing method M2 shown in FIG. 23, the task data 171, the worker data 172, and the fastening location data 173 are referred to as in the processing method M1 shown in FIG. 13. In FIG. 23, the illustration of these data is omitted.

First, the processing device 150 executes steps S1 and S2 as in the processing method M1. Next, the processing device 150 displays a virtual object based on the data stored in the fastening location data 173 (step S7). The processing device 150 determines whether a prescribed physical object comes into contact with the virtual object (step S8).

When the prescribed physical object comes into contact with the virtual object, the processing device 150 measures the position of the hand. The processing device 150 estimates the worker's posture based on the position of the MR device 100, the position of the worker's hand, and the worker's physique (step S21). The processing device 150 determines whether the estimated posture is appropriate (step S22). Specifically, a first determination of whether or not the distance between the MR device 100 and the hand falls outside the first range and a second determination of whether or not the inclination exceeds the first threshold are performed.

When the posture is determined to be inappropriate as a result of the first determination and the second determination, the processing device 150 prohibits the execution of the task (step S23). The processing device 150 determines the display content (step S24). The display content includes, for example, a danger of an inappropriate posture, instructions for making the posture more appropriate, etc. as shown in FIG. 22. When the display content is determined, the processing device 150 displays an alert (step S25).

Two or more ranges to be compared with the distance may be set. Two or more thresholds compared to the inclination may be set. In such a case, the display content may be changed according to the comparison result between the distance and each range or the comparison result between the inclination and each threshold. For example, the further the distance deviates from a wider range or the greater the inclination exceeds a greater threshold, the more the alert emphasizes the danger is output.

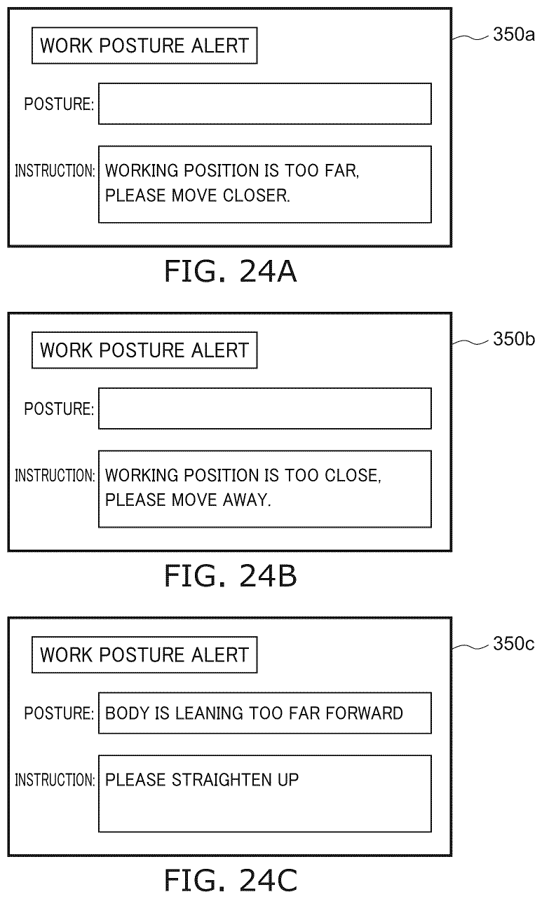

FIGS. 24A to 24C are schematic views illustrating display examples by the mixed reality device according to the modification of the embodiment.

As an example, one range to be compared with a distance is set, and two thresholds (a first threshold and a second threshold) to be compared with an inclination are set. The second threshold is larger than the first threshold. In step S24, the processing device 150 determines the display content based on the results of the first determination and the second determination. For example, when the distance exceeds the upper limit of the first range and the inclination exceeds the first threshold, the processing device 150 displays an alert 350a indicating that the worker's position is too far away, as shown in FIG. 24A. When the distance is below the lower limit of the first range and the inclination does not exceed the first threshold, the processing device 150 displays an alert 350b indicating that the worker's position is too close, as shown in FIG. 24B. When the distance is within the first range and the inclination exceeds the second threshold, the processing device 150 displays an alert 350c indicating that there is a danger of falling, as shown in FIG. 24C.

When the posture is determined to be appropriate in step S22, the processing device 150 allows the task to proceed (step S26). After step S25 or S26, the processing device 150 estimates the task location (step S9). That is, it is estimated that a screw is being turned to the fastening location corresponding to the virtual object with which the prescribed physical object came into contact. Thereafter, step S10 is executed as in the processing method M1. By determining whether the task posture is appropriate, the worker can be encouraged to work in a safer or more efficient posture. As a result, the safety or efficiency of the task can be improved.

The processing method M1 shown in FIG. 13 and the processing method M2 shown in FIG. 23 may be combined. Specifically, steps S3 to S6 of the processing method M1 may be executed after step S2. By combining the processing methods M1 and M2, it is possible to further improve safety and work efficiency.

Here, an example is mainly described in which an embodiment of the present invention is applied to the task of tightening a screw. Embodiments of the present invention may also be applied to the task of loosening a screw. When loosening the screw, a tool is used and a screw is turned, as shown in FIG. 5. In such a case, the virtual object is also displayed so that the task can be performed efficiently. In addition, work efficiency can be improved, and workers can work more safely.

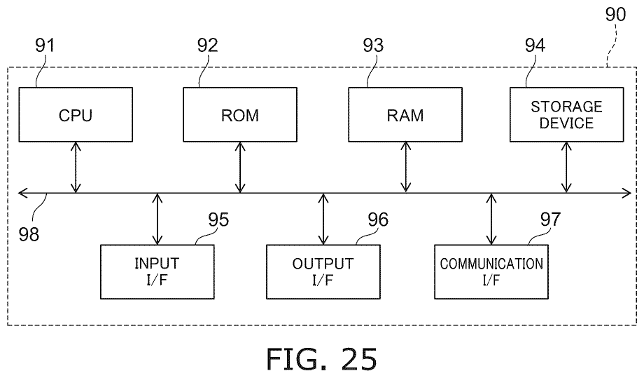

FIG. 25 is a schematic diagram illustrating a hardware configuration.

For example, a computer 90 shown in FIG. 25 is used as the processing device 3 or the processing device 150. The computer 90 includes a CPU 91, ROM 92, RAM 93, a storage device 94, an input interface 95, an output interface 96, and a communication interface 97.

The ROM 92 stores programs that control the operations of the computer 90. Programs that are necessary for causing the computer 90 to realize the processing described above are stored in the ROM 92. The RAM 93 functions as a memory region into which the programs stored in the ROM 92 are loaded.

The CPU 91 includes a processing circuit. The CPU 91 uses the RAM 93 as working memory to execute the programs stored in at least one of the ROM 92 or the storage device 94. When executing the programs, the CPU 91 controls the various components via a system bus 98 and performs various processing.

The storage device 94 stores data necessary for executing the programs and data obtained by executing the programs. The storage device 94 includes a solid state drive (SSD), etc. The storage device 94 may be used as the storage device 170.

The input interface (I/F) 95 can connect the computer 90 to input devices. The CPU 91 can read various data from input devices via the input I/F 95. The output interface (I/F) 96 can connect the computer 90 and output devices. The CPU 91 can transmit data to output devices (e.g., the projection devices 121 and 122) via the output I/F 96 and can display the information on the output devices.

The communication interface (I/F) 97 can connect the computer 90 and a device outside the computer 90. For example, the communication I/F 97 connects the digital tool and the computer 90 via Bluetooth (registered trademark) communication.

The data processing of the processing device 3 or the processing device 150 may be performed by only one computer 90. A portion of the data processing may be performed by a server or the like via the communication I/F 97.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD-R, DVD-RW, etc.), semiconductor memory, or another non-transitory computer-readable storage medium.

For example, the information that is recorded in the recording medium can be read by the computer (or an embedded system). The recording format (the storage format) of the recording medium is arbitrary. For example, the computer reads the program from the recording medium and causes a CPU to execute the instructions recited in the program based on the program. In the computer, the acquisition (or the reading) of the program may be performed via a network.

Embodiments of the present invention include the following features.

### (Feature 1)

A mixed reality device, configured to display a virtual object corresponding to a fastening location where a screw is turned, the virtual object being displayed at a position away from the fastening location,
the mixed reality device being configured to change a display position of the virtual object with respect to the fastening location according to a physique of a wearer.

### (Feature 2)

The mixed reality device according to feature 1, wherein
the mixed reality device is configured to change a height where the virtual object is displayed using a position of the fastening location and a length of a pre-registered tool.

### (Feature 3)

The mixed reality device according to feature 1, wherein
the mixed reality device is configured to
   calculate a first range within which a task can be performed to the fastening location using a position of the fastening location and a length of a pre-registered tool,
   calculate a second range within which the wearer can perform the task based on a position of the mixed reality device and the physique, and
   display the virtual object within an overlapping range of the first range and the second range.

### (Feature 4)

A mixed reality device, configured to display a virtual object corresponding to a fastening location where a screw is turned, the virtual object being displayed at a position away from the fastening location,
the mixed reality device being configured to change a display position of the virtual object with respect to the fastening location according to a positional relationship between the fastening location and the mixed reality device.

### (Feature 5)

The mixed reality device according to feature 4, wherein
in a case where the mixed reality device is positioned in a first direction with respect to the fastening location, the mixed reality device changes the display position of the virtual object towards the first direction, and
in a case where the mixed reality device is positioned in a second direction opposite to the first direction with respect to the fastening location, the mixed reality device changes the display position of the virtual object towards the second direction.

### (Feature 6)

A mixed reality device configured to display a virtual object corresponding to a fastening location where a screw is turned, the virtual object being displayed at a position away from the fastening location,
the mixed reality device measuring a distance between a hand of a worker and the mixed reality device in a case where a prescribed physical object comes into contact with the virtual object,
the mixed reality device then displaying an alert in a case where the distance is outside a first range set based on a physique of a wearer, or in a case where a tilt of the mixed reality device exceeds a first threshold.

### (Feature 7)

The mixed reality device according to any one of features 1 to 6, wherein
the mixed reality device is configured to recognize a prescribed marker, and set a three-dimensional coordinate system based on the marker, and
the position of the fastening location is preset in the three-dimensional coordinate system.

### (Feature 8)

The mixed reality device according to any one of features 1 to 6, wherein
the mixed reality device is configured to
   display a plurality of the virtual objects respectively corresponding to a plurality of the fastening locations, and
   display information indicating an order in which the screw is to be turned on each of the plurality of virtual objects.

### (Feature 9)

The mixed reality device according to any one of features 1 to 6, wherein
the mixed reality device is configured to determine whether the virtual object comes into contact with a prescribed physical object, and
in a case where the virtual object comes into contact with the prescribed physical object, the mixed reality device estimates that the screw is being turned to the fastening location.

### (Feature 10)

The mixed reality device according to feature 9, wherein
the mixed reality device is configured to associate data related to the estimated fastening location with a task record.

### (Feature 11)

The mixed reality device according to feature 10, wherein
the task record includes a torque detected when the screw was turned to the fastening location and a number of times the screw was turned to the fastening location, and
the mixed reality device is configured to
   compare the torque and the number of times with a required torque and a required number of times preset for the fastening location, respectively, and
   determine that an error is present in a case where the torque is insufficient compared to the required torque or in a case where the number of times is less than the required number of times.

### (Feature 12)

An acquisition system configured to acquire the physique referred by the mixed reality device according to feature 1 or 6,
the acquisition system configured to calculate the physique based on a distance between the mixed reality device and the hand of the wearer or from an image showing a body of the wearer.

### (Feature 13)

A processing method, causing a mixed reality device to:
display a virtual object corresponding to a fastening location where a screw is turned, the virtual object being displayed at a position away from the fastening location;
change a display position of the virtual object with respect to the fastening location according to a physique of a wearer or a positional relationship between the fastening location and the mixed reality device.

### (Feature 14)

A program, causing a computer to execute the processing method according to feature 13.

### (Feature 15)

A non-transitory computer-readable storage medium, storing the program according to feature 14.

According to the embodiment described above, a mixed reality device, processing method, program, and storage medium capable of improving work efficiency are provided. In addition, an acquisition system capable of automatically acquiring physique data referenced when using a mixed reality device, processing method, program, and storage medium is provided.

In the present specification, “or” indicates that “at least one or more” of the items listed in the text can be adopted.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. A mixed reality device, configured to display a virtual object corresponding to a fastening location where a screw is turned, the virtual object being displayed at a position away from the fastening location,
the mixed reality device being configured to change a display position of the virtual object with respect to the fastening location according to a physique of a wearer.

2. The mixed reality device according to claim 1, wherein
the mixed reality device is configured to change a height where the virtual object is displayed using a position of the fastening location and a length of a pre-registered tool.

3. The mixed reality device according to claim 1, wherein
the mixed reality device is configured to
calculate a first range within which a task can be performed to the fastening location using a position of the fastening location and a length of a pre-registered tool,
calculate a second range within which the wearer can perform the task based on a position of the mixed reality device and the physique, and
display the virtual object within an overlapping range of the first range and the second range.

4. A mixed reality device, configured to display a virtual object corresponding to a fastening location where a screw is turned, the virtual object being displayed at a position away from the fastening location,
the mixed reality device being configured to change a display position of the virtual object with respect to the fastening location according to a positional relationship between the fastening location and the mixed reality device.

5. The mixed reality device according to claim 4, wherein
in a case where the mixed reality device is positioned in a first direction with respect to the fastening location, the mixed reality device changes the display position of the virtual object towards the first direction, and
in a case where the mixed reality device is positioned in a second direction opposite to the first direction with respect to the fastening location, the mixed reality device changes the display position of the virtual object towards the second direction.

6. The mixed reality device according to claim 1, wherein
the mixed reality device is configured to recognize a prescribed marker, and set a three-dimensional coordinate system based on the marker, and
the position of the fastening location is preset in the three-dimensional coordinate system.

7. The mixed reality device according to claim 1, wherein
the mixed reality device is configured to
display a plurality of the virtual objects respectively corresponding to a plurality of the fastening locations, and
display information indicating an order in which the screw is to be turned on each of the plurality of virtual objects.

8. The mixed reality device according to claim 1, wherein
the mixed reality device is configured to determine whether the virtual object comes into contact with a prescribed physical object, and
in a case where the virtual object comes into contact with the prescribed physical object, the mixed reality device estimates that the screw is being turned to the fastening location.

9. The mixed reality device according to claim 8, wherein
the mixed reality device is configured to associate data related to the estimated fastening location with a task record.

10. The mixed reality device according to claim 9, wherein
the task record includes a torque detected when the screw was turned to the fastening location and a number of times the screw was turned to the fastening location, and
the mixed reality device is configured to
compare the torque and the number of times with a required torque and a required number of times preset for the fastening location, respectively, and
determine that an error is present in a case where the torque is insufficient compared to the required torque or in a case where the number of times is less than the required number of times.

11. An acquisition system configured to acquire the physique referred by the mixed reality device according to claim 1,
the acquisition system configured to calculate the physique based on a distance between the mixed reality device and the hand of the wearer or from an image showing a body of the wearer.

12. A mixed reality device configured to display a virtual object corresponding to a fastening location where a screw is turned, the virtual object being displayed at a position away from the fastening location,
the mixed reality device measuring a distance between a hand of a worker and the mixed reality device in a case where a prescribed physical object comes into contact with the virtual object,
the mixed reality device then displaying an alert in a case where the distance is outside a first range set based on a physique of a wearer, or in a case where a tilt of the mixed reality device exceeds a first threshold.

13. The mixed reality device according to any one of claim 12, wherein
the mixed reality device is configured to recognize a prescribed marker, and set a three-dimensional coordinate system based on the marker, and
the position of the fastening location is preset in the three-dimensional coordinate system.

14. The mixed reality device according to claim 12, wherein
the mixed reality device is configured to
display a plurality of the virtual objects respectively corresponding to a plurality of the fastening locations, and
display information indicating an order in which the screw is to be turned on each of the plurality of virtual objects.

15. The mixed reality device according to claim 12, wherein
the mixed reality device is configured to determine whether the virtual object comes into contact with a prescribed physical object, and
in a case where the virtual object comes into contact with the prescribed physical object, the mixed reality device estimates that the screw is being turned to the fastening location.

16. The mixed reality device according to claim 15, wherein
the mixed reality device is configured to associate data related to the estimated fastening location with a task record.

17. The mixed reality device according to claim 16, wherein
the task record includes a torque detected when the screw was turned to the fastening location and a number of times the screw was turned to the fastening location, and
the mixed reality device is configured to
compare the torque and the number of times with a required torque and a required number of times preset for the fastening location, respectively, and
determine that an error is present in a case where the torque is insufficient compared to the required torque or in a case where the number of times is less than the required number of times.

18. An acquisition system configured to acquire the physique referred by the mixed reality device according to claim 12,
the acquisition system configured to calculate the physique based on a distance between the mixed reality device and the hand of the wearer or from an image showing a body of the wearer.

19. A processing method, causing a mixed reality device to:
display a virtual object corresponding to a fastening location where a screw is turned, the virtual object being displayed at a position away from the fastening location;
change a display position of the virtual object with respect to the fastening location according to a physique of a wearer or a positional relationship between the fastening location and the mixed reality device.

20. A non-transitory computer-readable storage medium, storing a program for causing a computer to execute the processing method according to claim 19.
